(19) United States
(12) Patent Application Publication
(10) Pub. No.: US 2006/0009891 A1
(43) Pub. Date: Jan. 12, 2006

(54) Manipulable input device with adjustable magnetorhelogical motion damper

(75) Inventors: Andrzej M. Pawlak, Rochester Hills, MI (US); Jayson D. Pankin, Grosse Pointe, MI (US); Glenn Gomes-Casseres, Ann Arbor, MI (US)

Correspondence Address: DELPHI TECHNOLOGIES, INC.;M/C 480-410-202, 5828 DELPHI DRIVE, TROY, MI, 48098-2815, US

(73) Assignee: DELPHI TECHNOLOGIES INC.

(21) Appl. No.: 10/885,056

(22) Filed: Jul. 6, 2004

(51) Int. Cl. B60G 17/018; G06F 17/00

(52) U.S. Cl. 701/37; 701/38

(57) ABSTRACT

A method and apparatus for damping an input device, utilizes a damping element attached between a support and an input element of the input device. The damping element includes a cavity forming element and a magnetizable element. The cavity forming element defines one or more cavities containing a magnetorheological (MR) fluid. The magnetizable element is disposed at a position adjacent the MR fluid for impressing a magnetic field on the MR fluid, to thereby alter the viscosity of the MR fluid and damp the movement of the input element generated by the input. In some embodiments, the damper includes a compliant element with a porous segment having one of the one or more cavities therein containing the MR fluid, with the compliant member having a stiffness. Application of the magnetic field to the MR fluid changes the stiffness of the compliant member.

### TECHNICAL FIELD OF THE INVENTION

This invention relates to input devices for providing control inputs to a machine, and more particularly to providing damping of movement of such input devices to provide a desired tactile feel for a user of the control device.

### BACKGROUND OF THE INVENTION

It is common practice to utilize an input device, such as a keypad, joystick, a hand or thumb wheel, foot pedal, or lever, for communicating an input command to a machine, such as a computer, video game, a medical device, a robotic system, or other types of control systems.

It is also known to utilize some form of damping of the input, in such control devices, to provide a desired tactile feel or force feedback through the input device to the user. For example, U.S. Pat. No. 6,486,872, to Rosenberg, et al, discloses a method and apparatus for providing passive force feedback.

Prior input devices utilize a variety of types of damping devices, including hydraulic dampers using a magnetorheological (MR) working fluid, which has fluid properties that change when exposed to a magnetic flux. MR fluids contain minute ferromagnetic particles that align with one another when exposed to a magnetic flux. By causing the alignment of the ferromagnetic particles of the MR fluid to change, shear forces generated within the MR fluid, when the MR fluid is subjected to an external force, are altered in a manner that causes the apparent viscosity of the MR fluid to change. The operating characteristics of the damper are dependent upon the fluid properties of the MR working fluid. By controlling the level and orientation of magnetic flux applied to the MR fluid, the operating characteristics of the hydraulic damper can be altered to provide a desired level of damping.

Prior MR devices typically include a movable piston having one or more holes therein, for passage of the MR fluid. The movable piston also typically includes electrical coils for generating a magnetic flux in the holes of the movable piston, for causing the viscosity of the MR fluid to change as it travels through the holes in the piston.

The need to provide the movable piston, and to make the piston physically large enough so that it can include the holes and electrical coils, has caused prior damping devices using MR fluid to generally be relatively large, and not well suited to smaller sized input devices.

The present invention provides a method and apparatus, utilizing MR fluid, that is particularly suited for providing damping in smaller sized input devices, but can also be used in larger sized input devices to provide improved functionality, and other advantages that are not provided by prior input devices.

### SUMMARY OF THE INVENTION

The present invention provides an improved method and apparatus for damping an input device, through the use of a damping element adapted for attachment between a support, and an input element of the input device, which is configured for receiving an input through manipulation of the input element by a user. The input generates a movement of the input element. The damping element includes a cavity forming element and a magnetizable element. The cavity forming element defines one or more cavities containing a magnetorheological (MR) fluid. The magnetizable element is disposed at a position adjacent the MR fluid for impressing a magnetic field on the MR fluid, to thereby alter the viscosity of the MR fluid and damp the movement of the input element generated by the input.

In contrast to prior hydraulic dampers utilizing MR fluid, the magnetizable element is not required to be located in holes allowing passage of the MR fluid, and a movable piston is not necessarily required in all embodiments of the present invention.

In one form of the invention, the cavity forming element comprises a compliant member operatively connected between the input element and the support. The compliant member is formed from a resilient material, and defines at least one of the one or more cavities containing the magnetorheological fluid. The compliant member has a stiffness that is defined by the structure of the compliant member and the material properties of the resilient material and the MR fluid. Application of the magnetic field to the MR fluid changes the stiffness of the compliant member by changing the flid properties of the MR fluid in one or more of the one or more cavities of the compliant member.

The compliant member may include a porous segment forming at least one of the one or more cavities containing the MR fluid. The porous segment may be sponge-like, having a plurality of cells defining a plurality of the one or more cavities containing the MR fluid. The porous segment may also be fibrous, having a plurality of fibers forming a plurality of spaces therebetween defining a plurality of the one or more cavities containing the MR fluid. The compliant member may also be formed of a resilient material having veins or micro-tubes therein, oriented in an ordered array or randomly, in various embodiments of the invention, with the veins or micro-tubes forming the one or more cavities for the MR fluid.

In another form of the invention, the damping element includes a damper housing having a bore defining an axis, and a movable member disposed within the bore. The movable element is operatively attached to the input element for movement thereby with respect to the axis. The cavity forming element may include the housing, with the bore in the housing defining the cavity, and the cavity defining the axis. Application of magnetic flux, to the MR fluid in the cavity, increases resistance to movement of the movable element in the cavity. The movable element may further include a hole therein for passage of the MR fluid therethrough, with application of magnetic flux to the MR fluid in the cavity causing an increase in resistance to the passage of MR fluid through the hole in the movable element.

The movable element may be rotatable about the axis and may include one or more paddles extending therefrom. At least one of the paddles extending from the movable element may further include a hole therein for passage of the MR fluid therethrough, and wherein application of magnetic flux to the MR fluid in the cavity increases resistance to the passage of MR fluid through the hole in the at least one paddle of the movable element.

In some forms of the invention, a compliant element is disposed within the bore and operatively connected between the movable element and the housing, with the compliant element including a porous segment having one of the one or more cavities therein containing the magnetorheological fluid, with the compliant member further having a stiffness. Application of the magnetic field to the MR fluid changes the stiffness of the compliant member. The porous segment may be sponge-like, or fibrous. The compliant member may be fixedly attached to the housing and slidably contact the movable element. Conversely, the compliant member may be fixedly attached to the movable element and slidably contact the housing.

The invention may also take the form of a method for damping movement of an input element of an input device with respect to a support of the input device, utilizing a damping element as disclosed herein. The method may include, connecting the input element to the support with a damping element having a compliant member, and also having a compliant member defining one or more cavities containing an MR fluid. The method may further include additional steps such as: impressing a magnetic flux on the MR fluid; controlling the intensity of the magnetic flux impressed upon the MR fluid; setting a threshold value of stiffness of the compliant member by impressing a threshold level of magnetic flux intensity on the MR fluid; and/or controlling the stiffness of the compliant member by altering the threshold level of magnetic flux intensity.

The foregoing and other features and advantages of the invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIGS. 1 and 2 are schematic representations of exemplary embodiments of control systems, including input devices and MR damping elements, according to the invention, for receiving a linear input.

FIG. 3 is a schematic representation of an exemplary embodiment of a control system, including a rotary input device and MR damping element, according to the invention, for receiving a rotary input.

FIGS. 4a-4f are cross sectional views of six exemplary embodiments of a linear input device, according to the invention.

FIGS. 5 and 6 are enlarged representations of two exemplary embodiments of a compliant member according to the invention, formed from a porous sponge-like, or fibrous material, respectively.

FIGS. 7 and 8, respectively, are enlarged cross sectional views of MR damping elements, according to the invention, having a linearly movable member disposed in a bore containing MR fluid.

FIGS. 9 and 10 are side and end cross sectional views of a first exemplary embodiment of a rotary damping element, according to the invention.

FIGS. 11-13 are side cross sectional views of alternate exemplary embodiments of rotary damping elements, according to the invention.

FIGS. 14a-14c show several alternate embodiments of a movable element for a rotary damper, according to the invention, of the type shown in FIGS. 9 and 10.

FIGS. 15a-15e show several alternate embodiments of a movable element for a rotary damper, according to the invention, of the type shown in FIGS. 11-13.

FIGS. 16a-18b show alternate exemplary embodiments of a linear input device, according to the invention.

Throughout the drawings and the following descriptions of exemplary embodiments, like elements are identified with the same reference numerals.

### DETAILED DESCRIPTION

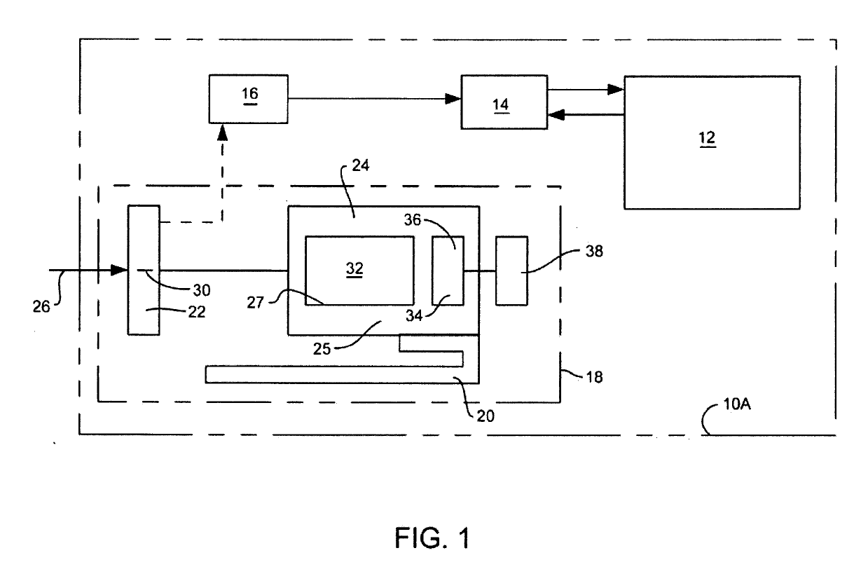

FIGS. 1-3 show three exemplary embodiments of a control system 10a, 10b, 10c, each including a controlled device 12, a controller 14, a sensor 16, and an exemplary embodiment of the invention in the form of an input device 18, including a support 20, an input element 22, and a damping element 24.

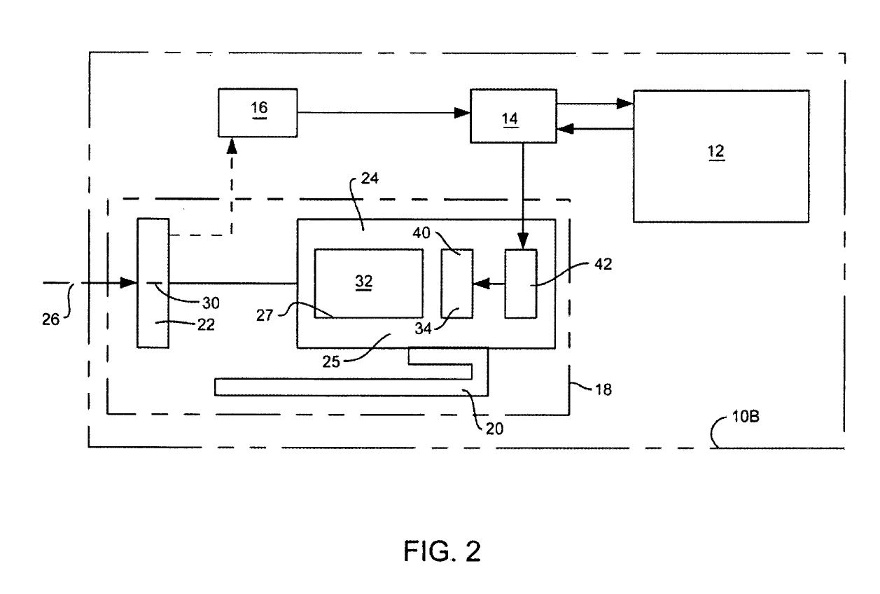

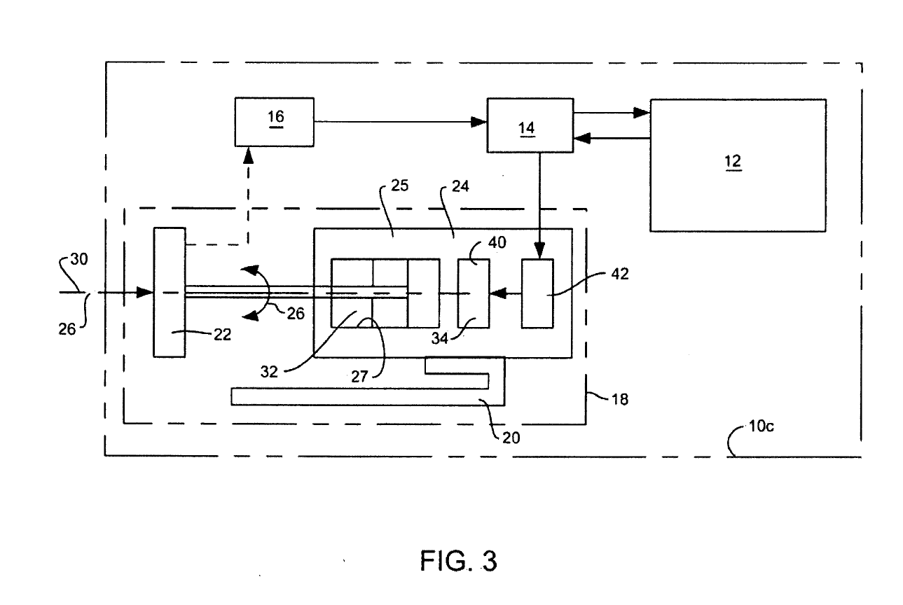

In each of the exemplary control systems 10a, 10b, 10c, the input element 22 is configured for receiving an input, through manipulation of the input element 22 by a user, for generating a movement of the input element 22. As described in more detail below, an input device 18 and damping device 24 of the invention can be configured for operation with inputs that are linear, rotary, a combination of linear and rotary, or applied obliquely to the input element 22. In the input devices 18 of FIGS. 1 and 2, the input is linearly directed, as indicated by arrows 26, along an axis 30 of the input element 22. In the input device 18 of FIG. 3, the input may be directed either linearly, as shown by arrow 26, or be a rotating input, as shown by arrow 28.

The sensor 16 is operatively connected for detecting an application of the input 26, 28 to the input element 22, and communicating an input signal indicative of the input 26, 28 to the controller 14. The controller 14 is operatively connected between the sensor 16 and the controlled device 12, and generates a control signal, which is communicated to the controlled device 12, for controlling the controlled device 12 in a predetermined manner as a function of the input 26, 28. The damping element 18 resists movement of the input element 22, in response to the input 26, 28.

In the embodiments of the control systems 10a, 10b, 10c shown in FIGS. 1-3, the controller 14 is also operatively connected to receive a feedback signal from the controlled device 12, but it will be understood, by those having skill in the art, that in other embodiments of the invention there may be no feedback signal and the controller will operate the controlled device 12 in an open-loop fashion. In the embodiments of the control systems 10b, 10c shown in FIGS. 2 and 3, the controller 14 is also operatively connected to the damping element 18, for controlling the level of damping applied to the input element 22.

In each of the exemplary embodiments described herein, the damping element 24 is attached between the support 20 and the input element 22. The damping element 24 in all embodiments includes a cavity forming element 25 defining one or more cavities 27 containing a quantity of magnetorheological (MR) fluid 32, and includes a magnetizable element 34 disposed at a position adjacent the MR fluid 32, for impressing a magnetic field on the MR fluid 32, to thereby damp the movement of the input element 22 generated by the input (26 or 28).

The input device 18 and damping element 24 of the invention, may take many forms, some examples of which are described below, in conjunction with the accompanying drawing figures.

In the embodiment of the damping element 24 shown in FIG. 1, the magnetizable element 34 is a permanent magnet 36, and the damping element 24 further includes a positioning apparatus 38 for adjusting the position of the permanent magnet 36 adjacent to the MR fluid 32 to a desired position adjacent the MR fluid 32. The positioning apparatus may be a set screw, or any other appropriate mechanism known in the art, which may be adjusted by hand or with a tool to alter the position of the permanent magnet 36 with respect to the MR fluid 32, to achieve a desired constant value of damping. This arrangement allows for the touch responsiveness of the input device 18 to be tailored to a particular user or control system application.

In the embodiments of the damping element 24 shown in FIGS. 2 and 3, the magnetizable element 34 is an electromagnet 40 for generating the magnetic flux, and the damping element 24 further comprises a magnetic flux controller 42 for adjusting the magnetic flux generated by the electromagnet 40 to a desired magnetic flux.

Although the exemplary embodiments of the control systems 10a, 10b, 10c show the sensor 16, controller 14, and electromagnet controller 42 schematically as separate components, they may be combined into one another, or divided differently than illustrated in FIGS. 1-3, in other embodiments of the invention.

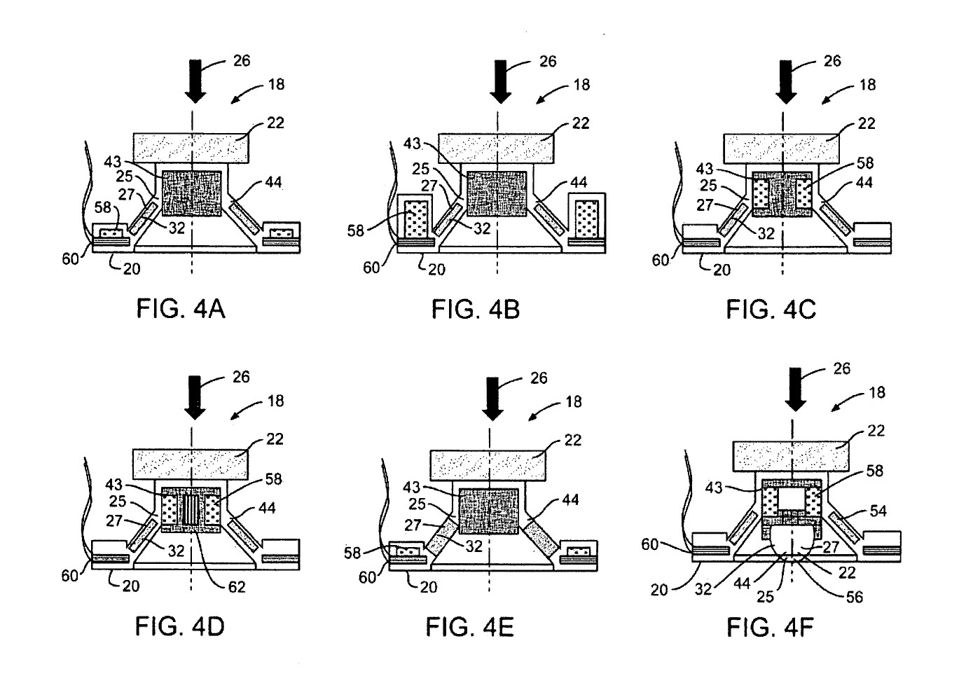

FIGS. 4a-4f show several exemplary embodiments of input devices 18, according to the invention, in the form of push buttons, or keys for a keypad, for receiving a linear input 26. The input devices 18 of FIGS. 4a-4f each include damping elements 24 in which the cavity forming element 25 includes a compliant member 44 operatively connected between the input element 22 and the support 20, and defining at least one cavity 27 containing the MR fluid 32. The compliant member 44 is formed of a material, such as such as silicone rubber, natural rubber, or any other suitable material that is pliable, bendable, resilient, and having a stiffness.

Each of the input devices 18 of FIGS. 4a-4f also includes a contact 43 that interacts with a sensor (not shown) to provide a signal when the linear input 26 is applied to the input element 22 (i.e. push-button or key).

In the exemplary input devices 18 of FIGS. 4a-4e, the compliant members 44 take the form of generally conically shaped skirts connecting the input element 22 to the support 20. In each of these embodiments, a portion of the compliant member 44 functions as the cavity forming element 25, and defines at least one internal cavity 27 containing the MR fluid 32.

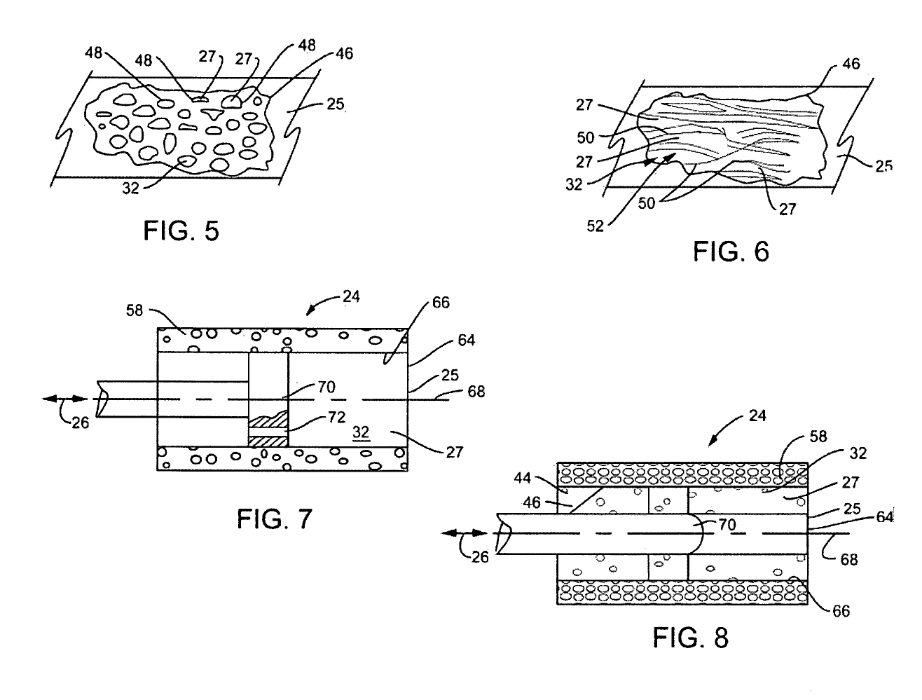

In some embodiments, the cavity forming element 25 may be impregnated with MR fluid, as shown in FIG. 4e. In other embodiments, the cavity forming element 25 may define a single cavity 27, or include a porous segment 46, as shown in FIGS. 5 and 6, forming a plurality of cavities 27 containing the MR fluid 32. The porous segment 46 may be sponge-like, as shown in FIG. 5, and have a plurality of cells 48 defining a plurality of cavities 27 containing the MR fluid 32. Alternatively, the porous segment 46 may be fibrous and have a plurality of fibers 50 forming a plurality of interstitial spaces 52 therebetween, defining a plurality of cavities 27 containing the MR fluid 32.

The input device 18 shown in FIG. 4f also includes a conical skirt 54 of compliant material, but the cavity forming element 25 takes the form of a compliant button 56 extending from the contact 43 to bear against a surface below the support 20.

In each of the input devices 18 of FIGS. 4a-4f, the magenetizable element includes an electrical coil 58 that is positioned adjacent the MR fluid 32 and operatively connected, via a circuit 60, to a source of electrical current (not shown), for impressing a magnetic field on the MR fluid 32. The circuit 60 may take any know form including wires, a circuit board or a flex circuit. In the embodiments of the input devices 18 shown in FIGS. 4a, 4b, and 4e, the electrical coil 58 is attached to the support 20. In the embodiments of FIGS. 4c, 4d, and 4f, the electrical coil 58 is attached to the contact 43. In the embodiment shown in FIG. 4d, the magnetizable element also includes a permanent magnet 62 disposed in the contact 43.

By controlling the level of electrical current applied to the electrical coil 58, the viscosity of the MR fluid 32 in the cavities 27 of the compliant members 25 of the input devices 18 shown in FIGS. 4a-4f can be changed and controlled. When the viscosity of the MR fluid 27 in the compliant members 25 is changed, the stiffness of the compliant members 25 is also changed a corresponding amount, to thereby damp the movement of the input element 22 generated by the input 26, for adjusting the tactile feel at the input element 22.

FIGS. 7-13 show exemplary embodiments of damping elements 24, according to the invention, in which the damping elements 24 include a damper housing 64 including a bore 66 defining an axis 68, and a movable member 70 disposed within the bore 66 and adapted for operative attached to an input element (not shown) for movement thereby with respect to the axis 68. The housing 64 functions as the cavity forming element and the bore 66 in the housing defines the cavity 27, with the cavity defining the axis 68. Each of these embodiments also includes an electrical coil 58, for applying magnetic flux to the MR fluid 32 in the cavity 27 to control the viscosity of the MR fluid, and the amount of damping applied through resistance to movement of the movable element 70 in the cavity.

FIGS. 7 and 8 show damping elements 24, for damping linear movement of the movable element 70 along the axis 68, in response to an input 26.

In the embodiment of FIG. 7, the movable element 70 includes a hole 72 therein for passage of the MR fluid 32 therethrough, and wherein application of magnetic flux to the MR fluid 32 in the cavity 27 increases resistance to the passage of MR fluid 32 through the hole 72 in the movable element 70. In other embodiments of the invention, the hole 72 in the movable element 70, of a damping element 24 of the type shown in FIG. 7, can be eliminated, and clearance provided between the movable element 70 and the bore 66 to force the MR fluid 32 to flow through the annular space formed by the clearance between the movable element 70 and the bore 6. In other embodiments, the movable element 70 may be take the form of a compliant member, formed from a porous material, that is sponge-like, or fibrous, as discussed above in relation to FIGS. 5 and 6.

In the embodiment of FIG. 8, a compliant element 44 is disposed within the bore 66 of the damping element 24, and operatively connected between the movable element 70 and the housing 64, with the compliant element 44 including a porous segment 46 having one of the one or more cavities 27 therein containing the MR fluid 32. Application of a magnetic field from the coil 58 to the MR fluid 32 changes the stiffness of the compliant member 25, to thereby change the damping provided. The porous segment 46 of the compliant member 44 may be sponge-like, or fibrous, as described above in relation to FIGS. 5 and 6. The compliant member 44 of the embodiment shown in FIG. 8 can be fixedly attached to the housing 64 and slidably contact the movable element 70, or may alternatively not be fixed to either the housing or the movable element 70.

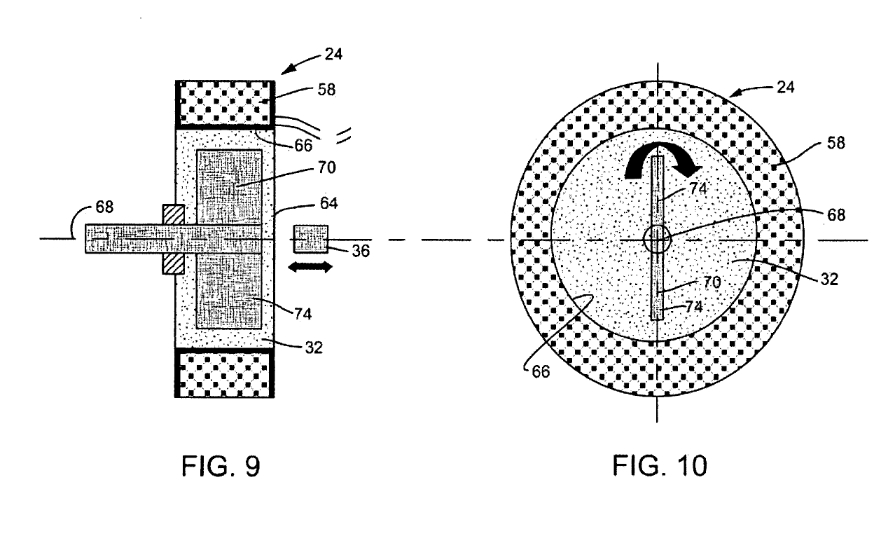

FIGS. 9-13 show exemplary embodiments of damping elements 24, according to the invention, in which the movable element 70 is rotatable about the axis 68.

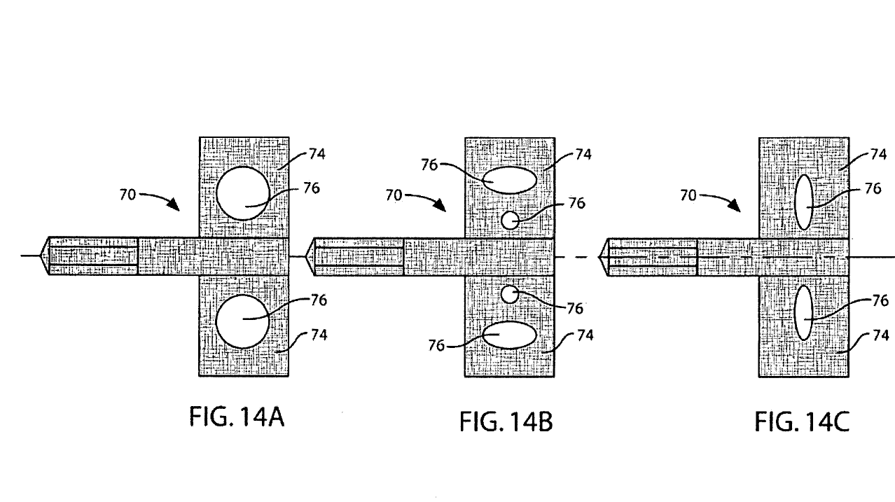

FIGS. 9 and 10 show two views of a damping element 24 wherein the movable element 70 includes one or more paddles 74 extending therefrom. The paddles 74 may one or more hole 76 therein, as shown in FIGS. 14a-14c, for passage of the MR fluid 32 therethrough, and wherein application of magnetic flux to the MR fluid 32 in the cavity 27 from the coil 70 increases resistance to the passage of MR fluid 32 through the holes 76 in the paddles 74.

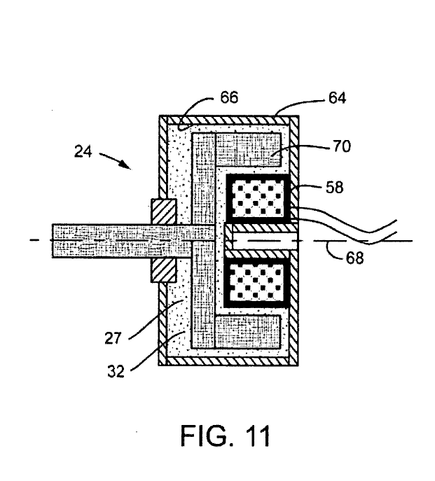

In the embodiment of the damping element 24 shown in FIGS. 9 and 10, the electrical coil extends around an outer periphery of the housing 64. FIG. 11 shows an embodiment of a damping element 24, according to the invention, in which the electrical coil 71 is located inside of the cavity defined by the bore 66 of the housing 64, and the movable element is contoured to wrap partially around the coil 71.

The embodiment of FIG. 9, also includes a permanent magnet 36, disposed adjacent the MR fluid 32. The permanent magnet 36 may be moved along the axis 68 to set a threshold value of viscosity of the MR fluid 32. In embodiments of the invention that do not have an electromagnet, a threshold value may also be set, using an electromagnet 58, by applying a continuous base signal level that is modulated to actively control the damping provided by the MR fluid 32.

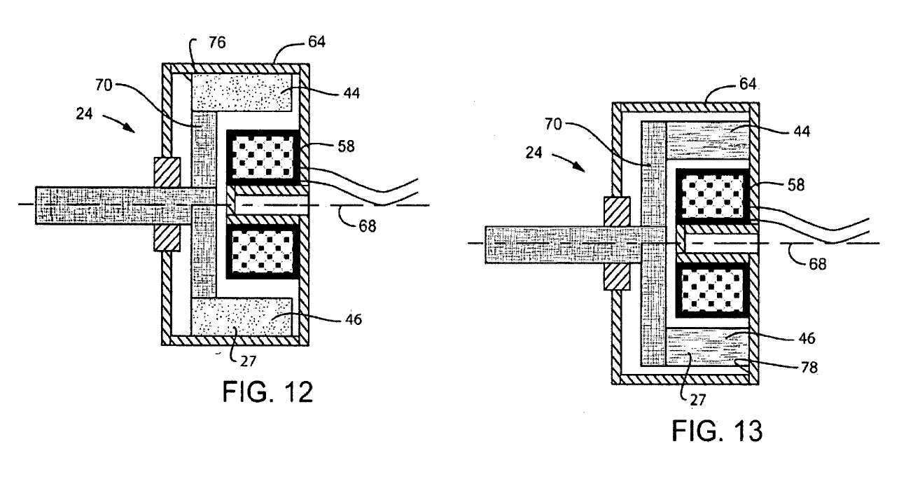

FIGS. 12 and 13 show an embodiment of a damping element 24 having a rotatable movable element 70 and a compliant member 44 disposed within the bore 66 and operatively connected between the movable element 70 and the housing 64, with the compliant member 44 including a porous segment 46 having one of the one or more cavities 27 (as shown in FIGS. 5 and 6) therein containing the MR fluid 32. Application of a magnetic field from the coil 58 to the MR fluid 32 changes the stiffness of the compliant member 44, to thereby change the damping provided.

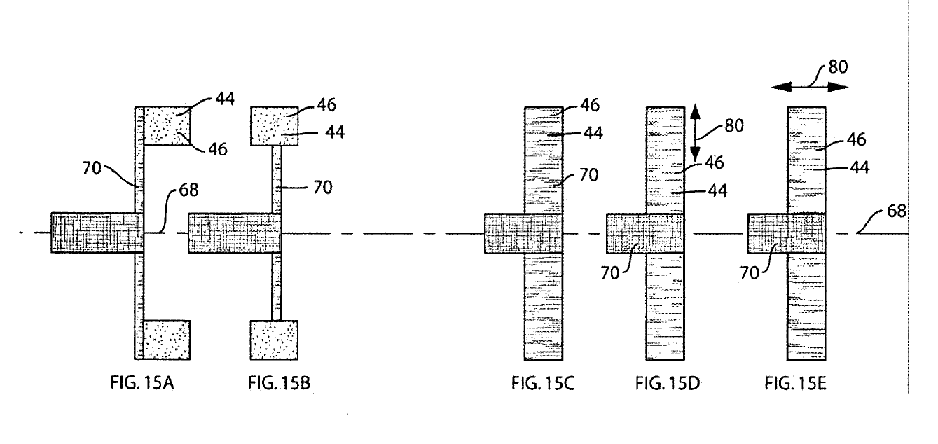

The porous segment 46 of the compliant member 44 may be sponge-like, or fibrous, as described above in relation to FIGS. 5 and 6. The compliant member 44 of the embodiments shown in FIGS. 12 and 13 can be fixedly attached to the housing 64 and slidably contact the movable element 70, or conversely be fixedly attached to the movable element 70 and slidably contact the housing 64, or may alternatively not be fixed to either the housing 64 or the movable element 70, in various embodiments of the invention. For example, in embodiment shown in FIG. 12, the compliant member 44 is sponge-like, fixedly attached to the movable element 70, and slidingly contacts a side wall 76 of the housing 64. In embodiment shown in FIG. 13, the compliant member 44 is a fibrous material, fixedly attached to the movable element 70, and slidingly contacts an end wall 78 of the housing 64. FIGS. 15a-I Se show yet other configurations for attaching a compliant member 44 having a porous segment 46 to a rotatable movable element 70, according to the invention.

In the embodiment of 15d the porous segments 46 is fibrous, and has a fiber direction (shown by arrows 80) extending primarily perpendicular to the axis 68. In the embodiment of 15e the porous segments 46 is fibrous, and has a fiber direction 80 extending primarily parallel to the axis 68. By orienting the fibers in a particular direction, the change in stiffness can be made directionally sensitive.

In embodiments of the invention having a movable element 70 operatively connected through a compliant member 44 to interact with a housing 64, such as those embodiments shown in FIGS. 8, 12, 13, and 15a-15e, it is preferable that the MR fluid be confined within the compliant member 44, rather than filling the inside of the housing 64 around the movable element 70, but this is not a requirement of the invention. MR fluid tends to be relatively expensive, and it is thus desirable to minimize the amount of MR fluid that is required, by containing it within the compliant member 44. It is contemplated, however, that in some embodiments of the invention, it may be desirable to have the movable element 70 and/or the compliant member 44 disposed in a cavity of the housing 64 that is at least partially filled with MR fluid.

Those skilled in the art will readily recognize that, while the embodiments of the invention disclosed herein are presently considered to be preferred, various changes and modifications can be made without departing from the spirit and scope of the invention.

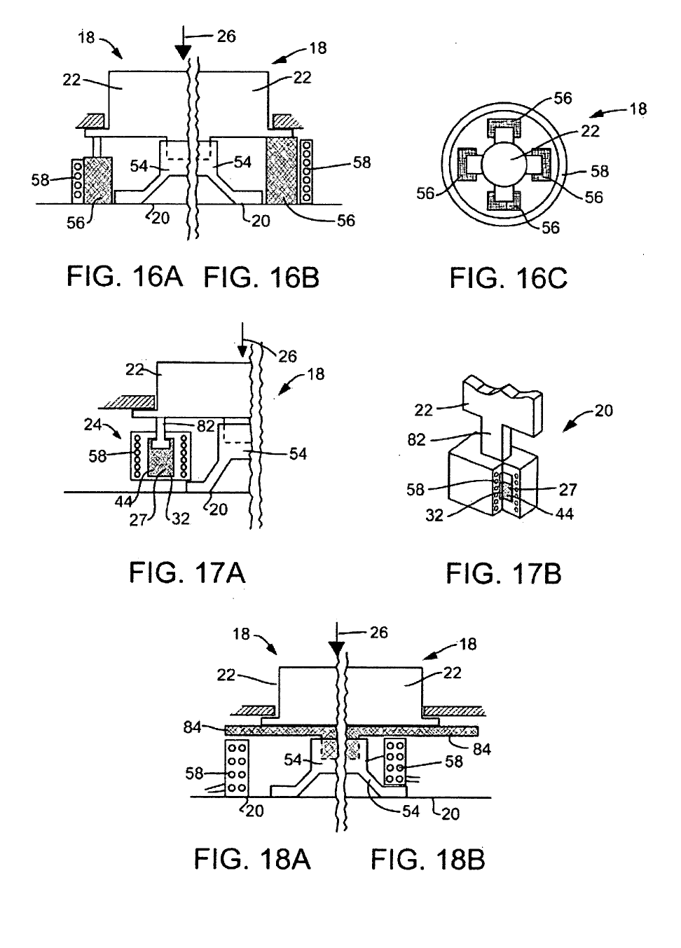

For example, FIGS. 16a-16c show alternate embodiments of an input device 18, having an input element in the form of a push button 22, for receiving a linear input 26, in which the button 22 is supported on a surface 20 by a conical skirt 54 of resilient material, forming a spring, and several buttons 56 of compliant material, with a common electrical coil 58 extending around all of the buttons 56 of compliant material.

FIGS. 17a and 17b show an alternate embodiment of an input device 18, having an input element in the form of a push button 22, for receiving a linear input 26, in which the button 22 is supported on a surface 20 by a conical skirt 54 of resilient material, forming a spring. The push button 22 includes downwardly extending legs 82 that form the movable elements of one or more damping elements 24, each having a cavity 27 containing MR fluid 32, and a coil 58 disposed around the cavity 27. Alternatively, the damping element 24 may include a compliant member 44 forming one or more cavities 27 containing MR fluid 32, with the coil 58 either surrounding or being embedded in the compliant member 44.

FIGS. 18a and 18b show other alternate embodiments of an input device 18, having an input element in the form of a push button 22, for receiving a linear input 26, in which the button 22 is supported on a surface 20 by a conical skirt 54 of resilient material, forming a spring, and a sheet or disk 84 of compliant material, with one or more electrical coils 58 disposed under the sheet or disk 84 of compliant material. In the embodiment shown in FIG. 18a, the coil 58 rests on the surface 20, and in the embodiment of FIG. 18b, the coil 58 is supported by the conical skirt 54 of resilient material.

It is contemplated that the invention may be used to significant advantage in many types of control applications for limiting motions/movements of a joystick and/or any device that uses linear and/or rotary motions.

For example, the invention may be utilized in a control system that limits one motion/movement to recognize and obey 2D linear controlled boundaries. An example of such an application is a controlled landing of an aircraft. The aircraft's steer-by-wire software limits motions/movements of the MR controlled joystick/device to prevent the plane form landing beyond left and/or right edges of a landing strip. Control software, using parameters for the landing strip that are stored in a database or uploaded from a transmitter at the landing strip, prevents the operator (pilot in this example) from moving an input element in such a way as to direct the aircraft beyond recognized limits of landing strip. A rotary element attached to a steering wheel, for example, will prevent movement of the joystick/device to a position that would steer the aircraft beyond the left or right edges of the landing strip, to thereby prevent pilot error.

The invention may also be used in a control system that limits two motions to recognize and obey 2D non-linear boundaries. An example of such an application is a controlled laser surgery device where safe boundaries of laser cuts are recognized by software and are ensured by MR controlled devices. Control software prevents the operator (surgeon in this example) from cutting beyond safe and recognized 2D limits of surgical cut areas, thereby preventing human error and helping the surgeon to minimize cuts.

In other embodiments of a control system, the invention is used to limit three motions by recognizing and obeying 3D linear and/or non-linear boundaries. An example of application is a controlled laser surgery joystick/device where safe boundaries of laser shape and depth of the cut are assured. Control software prevents the operator (surgeon in this example) from cutting beyond safe and recognized 3D limits of surgical cut areas, to thereby prevent human error and help the surgeon to minimize cuts.

It will be further recognized, by those skilled in the art, that MR controlled devices, according to the invention, can be controlled to follow any software-controlled trajectory by limiting motions/movements of a joystick and/or any device that uses linear and/or rotary motions.

For example, a software-controlled trajectory may limit one motion/movement, to recognize and follow a 2D linear controlled trajectory. An example of application is a controlled landing of an aircraft. The aircraft's steer-by-wire software restricts motions/movements of the MR controlled joystick/device to follow a software-controlled landing trajectory by limitation of one 2D motion/movement to recognize and follow a desired linear controlled trajectory. Control software helps the operator (pilot in this example) to operate with optimum performance by controlling the MR damper in such a manner that the pilot is prevented from making movements of the joystick that would cause the aircraft to deviate from the desired trajectory.

A software-controlled trajectory may also limit two motions/movements, to recognize and follow a 2D linear controlled trajectory. An example of such an application is a controlled laser surgery device where optimum laser cuts are assured. MR controlled devices, according to the invention, restrict motions/movements of a joystick to follow a software-controlled laser-cutting trajectory by limiting two motions/movements to recognize and follow a linear controlled trajectory. Control software helps the operator (surgeon in this example) to operate with optimum performance, by preventing human error and helping the surgeon to minimize cuts.

In other embodiments of a control system using the invention, a software-controlled trajectory may limit three motions/movements, to recognize and follow a 3D linear, and/or a non-linear controlled trajectory. An example of such an application is a controlled laser surgery device where an optimized 3D laser cut can be assured. Control software controls an MR damper, according to the invention, to keep the operator (surgeon in this example) within safe and recognized 3D limits of surgical cut areas, to thereby prevent human error and help the surgeon to minimize cuts.

The scope of the invention is indicated in the appended claims, and all changes or modifications within the meaning and range of equivalents are intended to be embraced therein.

We claim:

1. A damping element adapted for attachment between a support, and an input element configured for receiving an input through manipulation of the input element by a user, the input generating a movement of the input element, the damping element comprising:
a cavity forming element defining one or more cavities containing a magnetorheological fluid; and
a magnetizable element disposed at a position adjacent the magnetorheological fluid for impressing a magnetic field on the magnetorheological fluid, to thereby alter the viscosity of the magnetorheological fluid and damp the movement of the input element generated by the input.

2. The damping element of claim 1 wherein the magnetizable element comprises a permanent magnet, and the damping element further comprises a positioning apparatus for adjusting the position of the permanent magnet adjacent to the magnetorheological fluid to a desired position adjacent the magnetorheological fluid.

3. The damping element of claim 1 wherein the magnetizable element comprises an electromagnet for generating a magnetic flux, and the damping element further comprises a magnetic flux controller for adjusting the magnetic flux generated by the electromagnet to a desired magnetic flux.

4. The damping element of claim 1, wherein the cavity forming element further comprises a compliant member operatively connected between the input element and the support, the compliant member defining at least one of the one or more cavities containing the magnetorheological fluid, the compliant member having a stiffness.

5. The damping element of claim 4 wherein application of the magnetic field to the magnetorheological fluid changes the stiffness of the compliant member.

6. The damping element of claim 4 wherein the compliant member includes a porous segment forming at least one of the one or more cavities containing the magnetorheological fluid.

7. The damping element of claim 6 wherein the porous segment is sponge-like, having a plurality of cells defining a plurality of the one or more cavities containing the magnetorheological fluid.

8. The damping element of claim 6 wherein the porous segment is fibrous having a plurality of fibers forming a plurality of spaces therebetween defining a plurality of the one or more cavities containing the magnetorheological fluid.

9. The damping element of claim 1 wherein the damping element further comprises:
a damper housing including a bore defining an axis; and
a movable member disposed within the bore and operatively attached to the input element for movement thereby with respect to the axis.

10. The damping element of claim 9 wherein the cavity forming element comprises the housing, the bore in the housing defines the cavity, the cavity defines the axis, and wherein application of magnetic flux to the magnetorheological fluid in the cavity increases resistance to movement of the movable element in the cavity.

11. The damping element of claim 10 wherein the movable element further includes a hole therein for passage of the magnetorheological fluid therethrough, and wherein application of magnetic flux to the magnetorheological fluid in the cavity increases resistance to the passage of magnetorheological fluid through the hole in the movable element.

12. The damping element of claim 10 wherein the movable element is rotatable about the axis and includes one or more paddles extending therefrom.

13. The damping element of claim 12 wherein at least one of the paddles extending from the movable element further includes a hole therein for passage of the magnetorheological fluid therethrough, and wherein application of magnetic flux to the magnetorheological fluid in the cavity increases resistance to the passage of magnetorheological fluid through the hole in the at least one paddle of the movable element.

14. The damping element of claim 9 further comprising, a compliant element disposed within the bore and operatively connected between the movable element and the housing, the compliant element including a porous segment having one of the one or more cavities therein containing the magnetorheological fluid, the compliant member further having a stiffness.

15. The damping element of claim 14 wherein application of the magnetic field to the magnetorheological fluid changes the stiffness of the compliant member.

16. The damping element of claim 14 wherein the porous segment is sponge-like.

17. The damping element of claim 14 wherein the porous segment is fibrous.

18. The damping element of claim 14 wherein the compliant member is fixedly attached to the housing and slidably contacts the movable element.

19. The damping element of claim 14 wherein the compliant member is fixedly attached to the movable element and slidably contacts the housing.

20. An input device, comprising:
a support;
an input element configured for receiving an input through manipulation of the input element by a user, the input generating a movement of the input element; and
a damping element attached between the support and the input element;
the damping element containing a magnetorheological fluid, and including a magnetizable element disposed at a position adjacent the magnetorheological fluid for impressing a magnetic field on the magnetorheological fluid, to thereby damp the movement of the input element generated by the input.

21. The input device of claim 20, wherein the damping element further comprises a compliant member operatively connected between the input element and the support, the compliant member including at least one cavity holding the magnetorheological fluid.

22. The input device of claim 21 wherein application of the magnetic field to the magnetorheological fluid changes stiffness of the compliant member of the damping element.

23. The input device of claim 20 wherein the damping element defines a cavity containing the magnetorheological fluid, and further comprises a movable member disposed within the cavity and operatively attached to the input element for movement thereby.

24. The input device of claim 23, wherein the cavity further defines an interior wall surface thereof and the damping element further comprises, a compliant element disposed within the cavity and operatively connected between the movable element and the interior wall surface, the compliant element including a porous segment having one of the one or more cavities therein containing the magnetorheological fluid, the compliant member further having a stiffness.

25. The input device of claim 24 wherein application of the magnetic field to 5 the magnetorheological fluid changes the stiffness of the compliant member.

26. A method for damping movement of an input element of an input device with respect to a support of the input device, the method comprising, connecting the input element to the support with a damping element including a compliant member having a compliant member defining one or more cavities containing a magnetorheoligical (MR) fluid.

27. The method of claim 26, further comprising, impressing a magnetic flux on the MR fluid.

28. The method of claim 27, further comprising, controlling the stiffness of the compliant member of the damping element by controlling the intensity of the magnetic flux impressed upon the MR fluid.

29. The method of claim 28, further comprising, setting a threshold value of stiffness of the compliant member by impressing a threshold level of magnetic flux intensity on the MR fluid.

30. The method of claim 29, further comprising, controlling the stiffness of the compliant member by altering the threshold level of magnetic flux intensity.

31. An apparatus for controlling a controlled device in response to an input, the apparatus comprising;
a controller adapted for operative attachment to the controlled device;
an input device adapted for receiving the input and operatively connected to the controller for controlling the controlled device in response to the input; and
a damping element, including an MR fluid, operatively attached between the input device and the controller;
the damping element being controllable by the controller for providing damping of the input device in a manner that constrains movement of the input device in accordance with desired parameters of operation of the controlled device.

32. The apparatus of claim 31, wherein the desired parameters of operation define a spatial relationship of coordinates within which the controlled device is constrained to operate.

33. The apparatus of claim 31, wherein the desired parameters of operation define a spatial relationship of coordinates within which operation of the controlled device is precluded.
